(19) United States
(12) Patent Application Publication
(10) Pub. No.: US 2024/0026982 A1
(43) Pub. Date: Jan. 25, 2024

(54) MASS FLOW VALVE IN A VEHICLE

(71) Applicant: Robert Bosch GmbH, Stuttgart (DE)

(72) Inventor: Philipp Eichhorn, Waldbronn (DE)

(21) Appl. No.: 18/255,161

(22) PCT Filed: Nov. 22, 2021
(86) PCT No.: PCT/EP2021/082472

§ 371 Date: May 31, 2023

(30) Foreign Application Priority Data
Dec. 1, 2020 (DE) 10 2020 215 164.4

(51) Int. Cl. F16K 5/12

(52) U.S. Cl. CPC F16K 5/12; F16K 5/0605

(57) ABSTRACT

Then invention relates to a valve (1) for a fluid flow in a vehicle having a housing (2), comprising at least one first and one second connection opening (10, 11) which open into a valve chamber (3) of the housing (2), wherein a valve element (4) is mounted rotatably about a rotational axis (5) in the valve chamber (3), wherein two mutually spaced through-openings (13, 14) are provided on an outer surface (8) of the valve element (4), which through-openings are connected to each other by a through-bore (12), wherein at least one recess (15, 16, 22) is introduced in the outer surface (8) of the valve element (4), a drive element (6) being provided by means of which the valve element (4) is rotatable about the rotational axis (5),
characterized in that
the at least one recess (15, 16, 22) of the valve element (4) is formed separately from the through-openings (13, 14) and the through-bore (12), in the outer surface (8) of the valve body (4),
that an annular seal seat (71, 72) is arranged around the first and the second connection opening (10, 11), between the housing (2) and the valve element (4), wherein a seal seat (71, 72) seals off the connection opening (10, 11) from an intermediate chamber (21) which is formed between the housing (2) and the valve element (4),
that at least the first connection opening (10), the first through-bore (13) and the at least one recess (15, 16, 22) are arranged in a region in relation to the rotational axis (5) such that, depending on the rotation position of the valve element (4), an overlap between the first connection opening (10) and the recess (15, 16, 22) and the intermediate chamber (21) is adjustable, wherein the first through-bore (13) additionally overlaps the intermediate chamber (21).

### BACKGROUND

The invention relates to a valve for a mass flow, in particular for a vehicle.

DE 10 2017 101 208 A1 discloses a valve for a heat pump system in a vehicle. The valve has an inlet, at least two outlets and a valve element. The valve element has at least one passage and an expansion recess made in an outer surface of the valve element and connected to an opening of the passage.

### SUMMARY

The object of the invention is to provide an improved valve for a mass flow. In particular, a valve is to be provided which enables better controllability of the mass flow.

The proposed valve has the advantage that a usable angle range for controlling the mass flow is expanded.

In the context of the present invention, the term fluid is understood to mean a medium which, depending on the prevailing thermodynamic conditions, can be present both in a liquid phase and in a gaseous phase. A fluid of the type in question is a heat transfer medium which circulates within the fluid circuit. In particular, the fluid is a natural refrigerant such as hydrocarbons, carbon dioxide, ammonia, propane, butane, propene, water or a synthetic refrigerant such as chlorofluorocarbons or partly halogenated hydrofluorocarbons.

The proposed valve has a housing with at least one first and one second connection opening. The connection openings open into a valve chamber of the housing. In the valve chamber, a valve element is rotatably mounted around an axis of rotation. The valve element comprises a passage formed as a through-bore, for example, that opens into the outer surface of the valve element with a first and second through-opening. In addition, at least one recess is introduced into the outer surface in such a manner that it is spaced apart from the through-openings and the through-bore. Furthermore, the valve element is rotatable about an axis of rotation in the housing via a drive element. The connection opening openings can each have a valve seat that seals the connection opening openings from a gap formed between the valve element and the housing.

When viewed along the axis of rotation of the valve element, the at least one recess and the first through-opening are arranged at the same height as the first connection opening. The at least first connection opening, the first through-opening and the at least one recess are arranged in an area relative to the axis of rotation, such that a hydraulic opening cross-section between the first connection opening and the recess decreases for a predetermined rotational position range of the valve element as the angle of rotation of the valve element increases, while a hydraulic opening cross-section between the first connection opening and the first through-opening increases. Therefore, fluid flows over the recess and through the first through-opening. In this manner, a non-linear increase of the opening cross-section between the first connection opening and the first through-opening can be balanced with the increase of the angle of rotation of the valve element via the recess. In this manner, the increase of the total opening cross-section can be achieved in the direction of a preferably linear increase of the hydraulic opening cross-section of the valve with the angle of rotation.

In a further embodiment, at least one further recess and the second through-opening are arranged at the same height as the second connection opening, as viewed along the axis of rotation of the valve element. The at least second connection opening, the second through-bore and the at least further recess are arranged in an area relative to the axis of rotation such that, depending on the rotational position of the valve element, an overlap between the second connection opening and the further recess and the intermediate space is adjustable. The second through-bore also comprises an overlap with the intermediate space.

In a further embodiment, the recess, the first through-opening and the first connection opening are arranged and formed in such a manner that, in a first rotational position range of the valve element, the recess comprises a first overlap with the first connection opening and a second overlap with the intermediate space. In this manner, the recess establishes a connection between the first connection opening and the intermediate space. In addition, in the first rotational position range of the valve element, the first through-opening comprises a third overlap with the intermediate space. In addition, the intermediate space and/or the second through-opening are connected to the second connection opening. In this manner, a connection between the second connection opening and the first connection opening is enabled in the first rotational position range of the valve element.

If the valve element is now rotated further in the direction of rotation to a second rotational position range, the recess furthermore comprises a first overlap with the first connection opening and a second overlap with the intermediate space. At the same time, the first through-opening comprises a fourth overlap with the first connection opening and a third overlap with the intermediate space. In the second rotational position range, the second through-opening and/or the intermediate space are also connected to the second connection opening. In the second rotational position range, a superposition is thus carried out in which both the recess and the first through-opening each overlap with the first connection opening. In this position, a mass flow from the first connection opening to the second connection opening is possible directly via the first through-opening and the second through-opening of the through-bore and via the first connection opening, the recess, the intermediate space and the first through-opening. In this manner, an extended control of the mass flow is enabled. In particular, with the aid of the superposition, additional control of the mass flow via the recess, the intermediate space and the first through-opening can be achieved independently of the overlap of the first through-opening with the first connection opening. For example, a linearity of the increase in mass flow can be improved with the increase in the rotational position of the valve element in the rotational direction in this manner. The first and second rotational position ranges represent a set angle range of the rotational position of the valve element.

In one embodiment, the recess, the first through-opening and the first connection opening are formed in such a manner that upon further rotation of the valve element in the rotational direction in a third rotational position range, the recess no longer has an overlap with the first connection opening. In the third rotational position range, the first through-opening further comprises a fourth overlap with the first connection opening and no third overlap with the intermediate space. In the third rotational position range, the second through-opening is also connected to the second connection opening. In the third rotational position range, a mass flow between the two connection openings is only passed directly through the through-bore.

In a further embodiment, the first recess, the first through-opening and the first connection opening are formed in such a manner that a hydraulic opening cross-section between the first connection opening and the first through-opening increases in the first rotational position range, with an increase in the rotational position of the valve element, in particular linearly.

In a further embodiment, the recess, the first through-opening and the first connection opening are formed in such a manner that, as the angle of rotation of the valve element increases in the direction of rotation in the second rotational position range, the hydraulic opening cross-section between the first connection opening and the first through-opening and the recess increases, in particular increases linearly. In the second rotational position range, the hydraulic cross-section is defined both by the overlap of the first connection opening with the first through-opening and by the overlap of the first connection opening with the recess, the overlap of the recess with the chamber, and the overlap of the chamber with the first through-opening.

Depending on the chosen embodiment, instead of a one-piece recess, the recess can also be formed as a first partial recess and a second partial recess, wherein the first and second partial recesses are separately introduced in the outer surface of the valve element. When viewed along the direction of rotation of the valve element, the first and second partial recesses are arranged adjacent to one another in a partial angle range. In this manner, it is ensured that there is always a connection between the first connection opening and the intermediate space in the first and second rotational position ranges. Therefore, in a particular rotational position of the valve element, the first connection opening can be connected with the intermediate space via both the first partial recess and via the second partial recess. The formation of the recess in the form of a first and second partial recess allows for simplified manufacturing of the recess in the outer side of the valve element.

In one embodiment, the recess extends up to a predetermined distance from the first through-opening. Preferably, the recess can be symmetrically arranged in relation to a center of the through-opening as seen along the axis of rotation. An end surface of the recess facing an edge area of the first through-opening can be formed so that it is parallel to the edge area of the first through-opening. For example, the through-opening can possess an arc-shaped edge area. Therefore the end surface of the recess can preferably be formed in an arc shape and parallel to the course of the arc-shaped edge area. In this manner, improved linearization of the mass flow can be achieved with an increasing rotational position of the valve element.

The first partial recess can be arranged with a center axis, e.g. as viewed along the axis of rotation, at the level of a center of the first through-opening. The second partial recess can be arranged above or below the center of the first through-opening as viewed along the axis of rotation. For example, the first and second partial recesses can be introduced into the outer surface of the valve element in the form of strip-shaped recesses.

Depending on the selected embodiment, a third partial recess which is arranged in a mirroring symmetrical manner with respect to a center axis of the second partial recess can be provided. For example, the second partial recess is arranged above the first partial recess, and the third partial recess is arranged below the first partial recess. The first and second and, for example, third partial recesses are arranged within the area of the first through-opening when viewed along the axis of rotation.

In a further embodiment, the recess extends to a predetermined distance from the first through-opening. An end surface of the recess that faces the first through-opening can be formed so that it is parallel to an edge area of the first through-opening. This allows the end surface of the recess to be formed as close as possible to the edge area of the first through-opening. Thereby the least change possible in the mass flow in the rotational position of the valve element is achieved, wherein the recess no longer has any overlap with the first outlet opening.

In a further embodiment, the recess is integrally formed with a first partial section and a second partial section. The first partial section extends perpendicularly to the axis of rotation. For example, the first partial section is introduced into the outer surface of the valve element as a rectangular surface. The first partial section can be arranged with a center axis that is perpendicular to the axis of rotation and at the level of the center of the first through-opening. The second partial section is laterally brought outward from the first partial section at the end of the first partial section, and extends along the edge area of the first through-opening over a predetermined area in the direction of the axis of rotation, either upwards or downwards, for a predetermined distance. In this manner, a simple geometry of the recess that allows a desired increase of the mass flow can be provided, in particular a mass flow that is as linear as possible as the angle of rotation of the valve element increases. With an increasing angle of rotation of the valve element, an enlargement of the hydraulic opening cross-section between the first connection opening and the recess can be achieved by the second partial section. In this manner, a non-linear increase in the overlap between the first through-opening and the first connection opening can be equalized, in particular at the start of the overlap.

Depending on the selected embodiment, the recess comprises a third partial section, wherein the third partial section is formed symmetrically and opposite to the second partial section in relation to a center axis of the first partial section, and is connected to the first partial section. By forming the second and third partial sections, an improved flow guidance can be achieved. The second and third partial sections can form the shape of a partial circle, in particular arranged in mirror symmetry to the center axis of the first partial section. The center axis is preferably arranged perpendicularly to the axis of rotation.

In a further embodiment, the second and third partial sections are arranged in mirror symmetry to the center axis of the first partial section, wherein the second and third partial sections have a circular arc shape on a first side that faces the first through-opening. On a second side opposite the first side, the second and third partial sections have a straight surface. The second sides of the second and third partial sections are formed in mirror symmetry to the center axis of the first partial section. These shapes also exhibit improved flow behavior.

In all embodiments, the first and second recesses or further recesses can also be connected to each other via a passage within the valve element.

In addition, at least one recess can be connected to the passage and/or the through-openings in all embodiments.

### BRIEF DESCRIPTION OF THE DRAWINGS

The invention will be explained in further detail in the following text, with reference to the drawings. Shown are:

FIG. 1 a schematic diagram of a first embodiment of a valve having a spherical valve element,

FIG. 2 a schematic partial cut-out of the inner wall of the valve chamber,

FIG. 3 a schematic diagram of a second embodiment of the valve with a cylindrical valve element,

FIGS. 4 to 7 schematic representations of various rotational positions of the valve element when viewing the outer surface of the valve element and the schematic representation of the first connection opening and the intermediate space,

FIGS. 8 to 12 schematic diagrams of outer surfaces of various embodiments of the valve element,

FIG. 13 different rotational positions of the valve element when viewing the first through-opening and in a cross-section perpendicularly to the axis of rotation of the valve element,

FIG. 14 in a schematic diagram, a diagram for a characteristic curve of the hydraulic opening cross-section of the valve, depending on the angle of rotation of the valve element.

### DETAILED DESCRIPTION

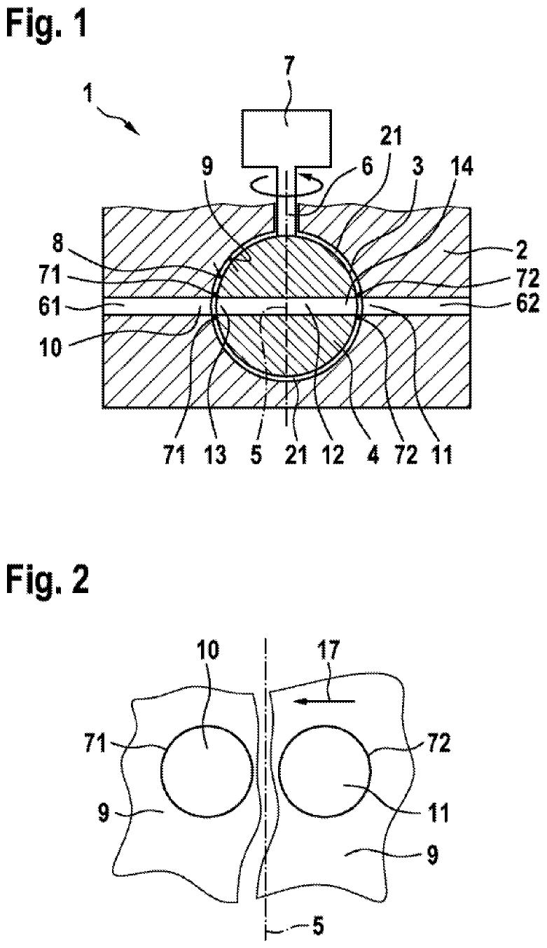

FIG. 1 shows a schematic cross-section of a valve 1, comprising a housing 2 with a valve chamber 3. In the valve chamber 3, a valve element 4 is mounted rotatably about an axis of rotation 5. A gap 21 is formed between the valve element 4 and the housing 2. The intermediate space 21 forms a flow-through volume between the valve element 4 and the housing 2.

The valve element 4 is in communication with a drive element 6 that is coupled to a drive 7. The drive element 6 is sealed against the housing 2 in such a manner that the passage of the drive element 6 is sealed against the intermediate space 21. With the aid of the drive 7, which is formed as an electrical actuator, for example, or as an electrical control element, the valve element 4 can be rotated about the axis of rotation 5 by using the drive element 6, which is formed in a cylindrical shape, for example. In the embodiment shown, the valve element 4 has a spherical outer surface 8. The valve chamber 3 comprises an inner wall 9, which is also spherical in large areas.

The housing 2 comprises a first connection 61, which leads from the outside of the housing 2 to the valve chamber 3, and opens into the valve chamber 3 with a first connection opening 10. A first valve seat 71 against which the outer surface 8 of the valve element forms a seal is formed around the first connection opening 10. The first valve seat can in particular be formed as a substantially annular sealing element, which forms a sealing interface between the housing and the valve element. The first connection opening 10 can be formed in the shape of a bore with a circular cross-section, for example. The housing 2 comprises a second connection 62, which leads from the outside of the housing 2 to the valve chamber 3, and opens into the valve chamber 3 with a second connection opening 11. The second connection opening 11 can be formed as a bore with a circular cross-section, for example. A second valve seat 72 can be formed around the second connection opening 11, against which the outer surface 8 of the valve element 4 forms a seal. The second valve seat can in particular be formed as a substantially annular sealing element, which forms a sealing interface between the housing and the valve element. In the embodiment shown, the first and second connection openings 10, 11 are arranged on an axis. Depending on the chosen embodiment, the first and second connection openings 10, 11 can also be arranged at a fixed angle in relation to each other.

The valve element 4 comprises a through-bore 12. The through-bore 12 extends from a first through-opening 13 to a second through-opening 14. The first and second through-openings 13, 14 are arranged on the outer surface 8 of the valve element 4. In the embodiment shown, the through-bore 12 is provided in the form of a straight bore. Depending on the chosen embodiment, the through-bore 12 can also have other forms. In particular, the first and second through-openings 13, 14 can be arranged so that they are not on an axis through the center of the valve element. In addition, the sizes and shapes of the through-openings 13, 14 can be formed differently.

FIG. 2 shows schematic partial cut-outs of the inner wall 9 of the valve chamber 3. The first connection opening 10 is surrounded by the annular sealed seat 71. In an analogous manner, the second connection opening 11 can also be surrounded by a second annular sealed seat 72. The inner wall 9 of the valve chamber 3 has a substantially spherical shape analogously to the outer surface 8 of the valve element 4.

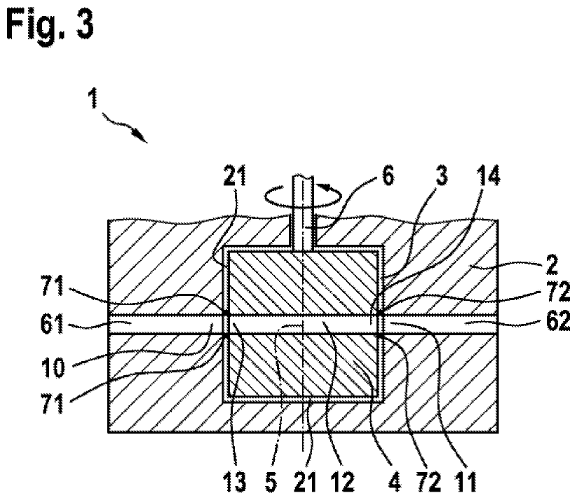

Depending on the selected embodiment, the valve 1 can also have a cylindrical valve element 4 and a cylindrical valve chamber 3, as shown in FIG. 3. With the exception of the different shapes of the valve chamber 3 and the valve element 4 and the sealed seats, the valves 1 of FIGS. 1 and 3 are formed in the same manner.

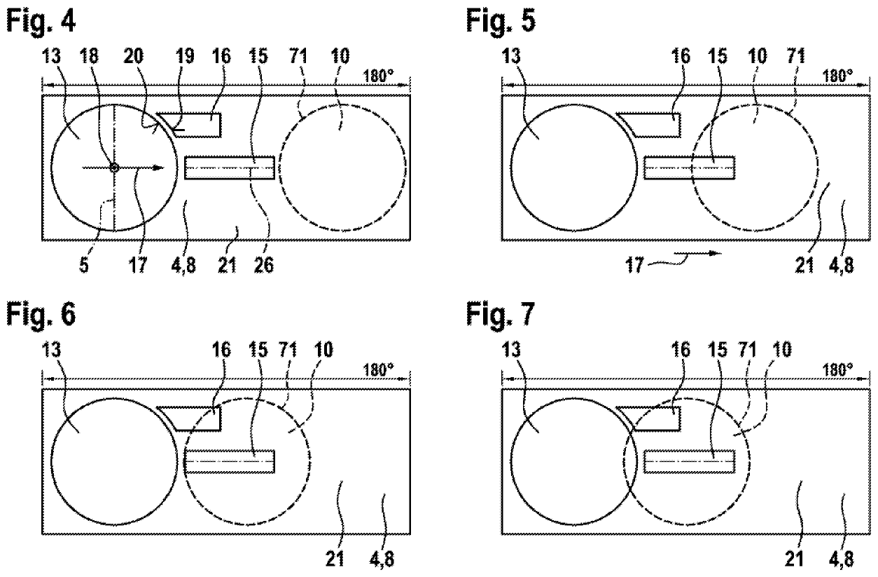

FIG. 4 shows a schematic representation of a two-dimensional projection of a partial section of the outer surface 8 of the valve element 4 over a 180° angle range. The axis of rotation 5 is arranged perpendicularly to the axis of the angle shown. The valve element 4 can have both a spherical and a cylindrical outer surface 8. The depicted view represents one half of the outer surface 8 of the valve element 4. Depending on the chosen embodiment, the outer surface 8 of the valve element 4 can have a second half that is identical to the half shown. Depending on the chosen embodiment, the second half of the outer surface 8 can also be formed differently. The outer surface 8 comprises the first through-opening 13 and a first recess 15 that is introduced into the outer surface 8. FIG. 4 shows the outer surface 8 in a plane of the axis of rotation 5, wherein the axis of rotation 5 is shown schematically in the area of the first through-opening 13. A direction of rotation 17 in which the valve element 4 can be rotated is shown vertically to the axis of rotation 5. A center 18 of the first through-opening 13 is also shown. The first through-opening 13 has a circular cross-section. Depending on the chosen embodiment, the first through-opening 13 can also have a different cross-section. The first recess 15 has the shape of a rectangular surface in the cross-section to the surface of the outer surface 8, which is arranged substantially perpendicularly to the axis of rotation 5. The first recess 15 is arranged with a gap to the first through-opening 13. Furthermore, the first recess 15 is arranged with a center axis 26 perpendicularly to the axis of rotation and in relation to the axis of rotation 5, at the level of the center 18 of the first through-opening 13. Depending on the chosen embodiment, the first recess 15 can also take other forms and/or be arranged at a different level relative to the first through-opening 13.

In the embodiment shown, a second recess 16 is additionally introduced in the outer surface 8 of the valve element 4. The second recess 16 is arranged above the first recess 15 and within a height range of the first through-opening 13 in relation to the rotational axis 5. In the embodiment shown, the second recess 16 has a width along the axis of rotation 5 that is similar to the first recess 15.

The second recess 16 is arranged with a gap to the first recess 15 and with a gap to the first through-opening 13. In addition, when viewed in the direction of rotation 17, the second recess 16 does not extend as far from the first through-opening 13 as the first recess 15. The second recess 16 has an end surface 19 which faces an edge area 20 of the first through-opening 13. The end surface 19 is formed parallel to the edge area 20. Depending on the chosen embodiment of the second recess 16, the end surface 19 can also have a different shape, in particular as a straight end surface 19, arranged parallel to the axis of rotation 5.

The first and second recesses 15, 16 can have different depths along the direction of rotation at which they are introduced into the outer surface 8 of the valve element 4. In particular, the depth of the first and second recesses 15, 16 can increase towards the first through-opening 13. The cross-sectional surfaces and the depths of the first and second recesses 15, 16 are formed so as to achieve a desired hydraulic opening cross-section. The hydraulic opening cross-section refers to the hydraulic flow cross-section.

FIG. 4 schematically shows the first connection opening 10 with the first valve seat 71 in the form of a dashed circle. The intermediate space 21 abuts the outer surface 8 outside the seal seat 71 of the first connection opening 10. In the shown rotational position of the valve element, the first and second recesses 15, 16 have an overlap with the intermediate space 21. Likewise, the first through-opening 13 has an overlap with the intermediate space 21. However, since there is no overlap with the first connection opening 10, no mass flow can flow through the valve. Therefore the valve is in a closed position.

FIG. 5 shows the two-dimensional projection of the partial section of the outer surface 8 of the valve element 4 of FIG. 4 in a schematic representation, with a rotational position of the valve element 4 in which the valve element 4 has been moved further by an angle range in the rotational direction 17 as compared to the position of FIG. 4. In this rotational position, the first recess 15 overlaps the first connection opening 10. In addition, the first and second recesses 15, 16 overlap with the intermediate space 21. Furthermore, the first through-opening 13 overlaps the intermediate space 21. In addition, the second through-bore is connected with the second connection opening. In this situation, a connection is therefore opened via the first connection opening 10, the first recess 15, the intermediate space 21, the first through-opening 13, the through-opening 14, the second through-opening 14 and the second connection opening 11. In addition, the intermediate space 21 can be connected with the second connection opening 11. Therefore a mass flow can flow through the valve 1.

FIG. 6 shows the schematic representation of the two-dimensional projection of the partial section of the outer surface 8 of the valve element 4 for a further rotational position of the valve element 4, in which the valve element 4 has been moved further along the direction of rotation 17 as compared to the position of FIG. 5. The first through-opening 13 overlaps with the intermediate space 21. In this position, the first recess 15 furthermore overlaps with the first connection opening 10, but no longer overlaps with the intermediate space 21. The second recess 16 overlaps with the first connection opening 10. Furthermore, the second recess 16 overlaps with the intermediate space 21. In this position, the second through-opening 14 and/or the intermediate space are also connected to the second connection opening 11. In this manner, a connection between the first connection opening 10 and the second connection opening 11 is also opened in this rotational position of the valve element 4. The connection leads via the second recess 16, the intermediate space 21 and the first through-opening 13, the through-bore and the second through-opening 14 and/or the intermediate space 21.

FIG. 7 shows the schematic representation of the two-dimensional projection of the partial section of the outer surface 8 of the valve element 4 for a fourth rotational position of the valve element 4, in which the valve element 4 has been moved forward by a further angle range in the rotational direction 17 as compared to the position of FIG. 6. In this position, there is now a direct overlap between the first connection opening 10 and the first through-opening 13 and the second recess 16. The second through-opening 14 can overlap with the second outlet opening 11. In addition, the second recess 16 overlaps with the intermediate space 21, which is also adjacent to the first through-opening 13. Therefore a mass flow via the first connection opening 10, the second recess 16 and the intermediate space 21 to the first through-opening is also given. In addition, the intermediate space 21 can be connected with the second connection opening. Therefore the valve is also open in this rotational position.

Preferably, the first through-opening 13, the intermediate space 21, the first and second recesses 15, 16 and the first connection opening 10 are formed in such a manner that there is an increase between the rotational positions of the valve elements 4 of FIGS. 4 and 7 in the hydraulic opening cross-section between the first connection opening 10 and the first through-opening 13, and the first and second recesses 15, 16, with an increase in the angle of rotation. Preferably, the increase in the hydraulic opening cross-section occurs linearly with the increase in the angle of rotation in the direction of rotation.

If the valve element 4 is now rotated further in the direction of rotation starting from the position in FIG. 7, the overlap between the first through-opening 13 and the first connection opening 10 continuously increases, so that the hydraulic opening cross-section continues to increase until a complete overlap between the first through-opening 13 and the first connection opening 10 is present. Preferably, the first through-opening 13, the intermediate space 21 and the first connection opening 10 are formed in such a manner that there is an increase in the hydraulic opening cross-section between the first connection opening 10 and the first through-opening 13 with an increase in the rotational angle between the rotational position of FIG. 7 and the complete overlap between the first through-opening 13 and the first connection opening 10. Preferably, the increase in the hydraulic opening cross-section occurs linearly with the increase in the angle of rotation in the direction of rotation. During this rotation of the valve element 4, the second through-opening 14 is also connected to the second connection opening 11. Depending on the chosen embodiment, the second recess 16 can also be omitted.

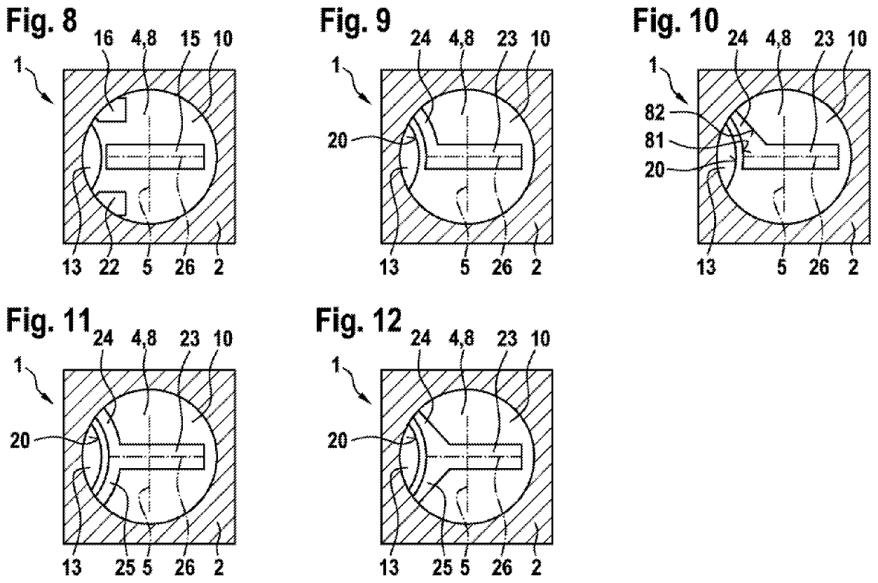

The principle of superposition of recesses that are formed separately from the first through-opening can be realized with various shapes of the recesses. The following FIGS. 8 to 12 show further possible embodiments of the outer surface 8 of the valve element 4. All outer surfaces 8 described can be formed on a spherical or cylindrical valve element 4.

FIG. 8 shows a schematic representation of a valve 1 with an outward view of the first connection opening 10 with an embodiment of a valve element 4, which has an outer surface 8 according to FIG. 4, but wherein a third recess 22 is additionally provided, which is preferably arranged in mirror symmetry in relation to the second recess 16 with reference to a center axis 26 of the first recess 15. The center axis 26 is arranged perpendicularly to the axis of rotation 5. The third recess 22 is also introduced into the outer surface 8 of the valve element 4.

Depending on the selected embodiment, the third recess 22 and the second recess can also be connected with the first recess 15 via a further recess in the outer surface 8 of the valve element 4.

FIG. 9 shows a schematic diagram of a valve 1 with an outward view of the first connection opening 10 with a further embodiment of a valve element 4, in which the first recess 15 comprises a first partial section 23 and a second partial section 24. The first partial section 23 is centered along the axis of rotation 5 in relation to a center point of the first through-opening 13. In addition, the first partial section 23 extends perpendicularly to the axis of rotation in the direction of rotation, and is formed as a straight section. The second partial section 24 extends laterally upwards from an end region of the first partial section 23 which faces the first through-opening 13. The second partial section 24 extends along a predetermined segment of the edge section 20 of the first through-opening 13 away from the center axis 26. Preferably, the second partial section 24 can be arranged parallel to the edge section 20 of the first through-opening.

FIG. 10 shows a schematic representation of a valve 1 with an outward view of the first connection opening 10, with a further embodiment of a valve element 4 having an outer surface 8, which has a recess with a first partial section 23 and a second partial section 24, wherein the first partial section 23 is identical to the embodiment of FIG. 9. The second partial section 24 is formed on the side 81, which faces the edge section 20 of the first through-opening 13, along the edge section 20, in particular parallel to the edge section 20, as in FIG. 9. However, the opposing second side 82 of the second partial section 24 is formed as a straight side. In this manner, an improved flow can be achieved as compared to FIG. 9, since a transition area between the first partial section 23 and the second partial section 24 has a lower directional flow change as compared to FIG. 9.

FIG. 11 shows a schematic representation of a valve 1 with an outward view of the first connection opening 10 with a further embodiment of a valve element having an outer surface 8, which is substantially formed according to FIG. 9, wherein a third partial section 25 is provided in addition to the second partial section 24. The third partial section 25 is arranged in mirror symmetry in relation to the second partial section 24 with reference to a center axis 26 of the first partial section 23. In this manner, a further improvement in flow can be achieved.

FIG. 12 shows a schematic diagram of a valve 1 with an outward view of the first connection opening 10 with a further embodiment of a valve element 4 having an outer surface 8, which is formed substantially according to the embodiment of FIG. 10, wherein, however, a third partial section 25 is also formed, wherein the third partial section 25 is arranged in mirror symmetry to the second partial section 24 in relation to the center axis 26 of the first partial section 23. This can likewise bring about a further improvement of the flow.

In a symmetrical configuration of the valve element 4 and a symmetrical arrangement of the second connection opening, the views through the second connection opening for the respective rotational position of the valve element 4 of FIGS. 8 to 12 are identical to the views shown in FIGS. 8 to 12 of the first connection opening 10. Depending on the chosen embodiment, the views through the second connection opening for the particular rotational position of the valve element 4 of FIGS. 8 to 12 can also be different from the views shown for FIGS. 8 to 12 of the first connection opening 10.

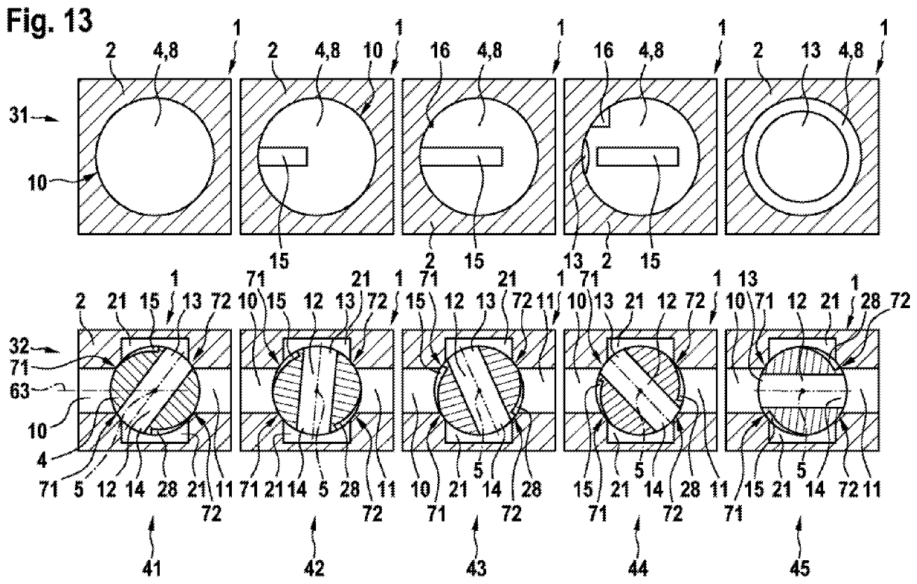

FIG. 13 shows various views of the valve for various rotational positions of the valve element 4 and the overlap of the recesses 15, 16 of the valve element 4 of FIG. 4 with the first connection opening 10. In a first row 31, schematic views are shown from the outside of the valve 1 with a view of the first connection opening 10 and the outer surface 8 of the valve element 4 for different valve rotational positions. Analogously to the respective view of the rotational positions of the valve element 4 of the first row 31, the corresponding rotational positions of the valve element 4 are shown in a section perpendicularly to the axis of rotation 5 at a center of the through-bore 12 in a second row 32.

In this example, the valve element 4 is furthermore identically formed in the area of the first through-opening 13 and in the area of the second through-opening 14, wherein identical first and second recesses 15, 28 are arranged at both through-openings 13, 14. The valve element 4 therefore has the shape according to FIG. 4 on a circumference of the outer surface 8 twice, respectively. The recesses are herein arranged in mirror symmetry in relation to the axis of rotation 5 of the valve element 4. Due to the cross-section through the middle of the through-bore 12, only the first recess 15 and the opposite further first recess 28 are visible in the figures of the second row 32. The valve shown has a valve chamber 3 which is formed in mirror symmetry to a central plane 63. The central plane 63 passes through the center of the first connection opening 10 and the axis of rotation 5. Therefore an intermediate space 21 is formed between the inner wall 9 of the valve chamber 3 and the valve element 4, wherein medium can flow around the valve element. Therefore a cross-section through the housing 2 and through the first and second connection openings 10, 11, the intermediate space 21, and the valve element 4 is shown in the second row 32.

In the first gap 41, the valve 1 is closed. Neither one of the recesses 15, 28 nor the first through-opening 13 overlaps with the first connection opening 10. The valve element 4 is now moved counterclockwise until there is an overlap between the first recess 15 and the first connection opening 10, as schematically shown in the first row of the second gap 42. At the same time, there is an overlap of the intermediate space 21 with the first recess 15 and the first through-opening 13, as shown in the figure of the second gap 42 and the second row 32. There is also an analogous overlap between the further first recess 28 and the second connection opening 11. In this rotational position, there is accordingly a connection between the first connection opening 10 and the second connection opening 11. The connection is made via the first connection opening 10, the first recess 15, the intermediate space 21, the first through-opening 13, the through-bore 12, the second through-opening 14, the intermediate space 21, the further first recess 28 and the second connection opening 11. This position corresponds to the position of FIG. 5.

If the valve element 4 is now moved counterclockwise, a rotational position is obtained, which is shown in the third gap 43. The third gap 43 of FIG. 10 corresponds to the representation of the position of FIG. 6. As shown in the first row 31 of the third gap 43, there is an overlap between the first connection opening 10, the first recess 15, and a part of the second recess 16. In addition, there is an overlap of the intermediate space 21 with the second recess 16 and the first through-opening 13. There is an analogous overlap between the second connection opening 11, the further first recess 28 and part of the further second recess. In addition, there is an overlap of the intermediate space 21 with the further second recess 28 and the second through-opening 14.

In the third gap 43 and in the second row 32, the cross-section for this rotational position is shown. In this rotational position of the valve element 4, there is also a connection between the first connection opening 10 and the second connection opening 11. Herein the first connection opening 10 is connected to the second recess 16, the second recess 16 is connected to the intermediate space 21, the intermediate space 21 is connected to the first through-opening 13, the first through-opening 13 is connected via the second through-opening 12 to the second through-opening 14, the second through-opening 14 is connected to the intermediate space 21, the intermediate space 21 is connected to the further second recess, and the further second recess is connected to the second recess 11.

If the valve element 4 is now rotated further counterclockwise, an overlap is achieved between the first through-opening 13 and the first connection opening 10, as shown in the figure of the first row 31 and the fourth gap 44. In the first row of the fourth gap, the overlap of the first connection opening 10 with the first recess 15, the second recess 16 and the first through-opening 13 is shown. This rotational position corresponds to FIG. 7. Analogously, the cross-section through the valve for this rotational position is shown in the second row 32 of the fourth gap 44. In this rotational position of the valve element 4, there is a direct connection between the first connection opening 10 via the first through-opening 13, the through-bore 12, the second through-opening 14 and the second connection opening 11. In addition, there is also a connection between the first connection opening 10, via the second recess 16, the intermediate space 21, the first through-opening 13, the through-bore 12, the second through-opening 14, the intermediate space 21, and the further second recess 28 towards the second connection opening 11. Furthermore, there is a connection between the first connection opening 10 via the intermediate space 21 and the second connection opening 11.

If the valve element 4 is moved counterclockwise, a complete overlap of the first through-opening 13 with the first connection opening 10 is achieved, as shown in the figure of the first row 31 and the fifth gap 45. Therefore there is only one connection between the first and the second connection openings 10, 11, directly via the through-bore 12 and the first and the second through-opening 13, 14, as also shown in the figure of the second row 32 and the fifth gap 45.

Analogously, the embodiments of the valve elements 4 shown in FIGS. 8 to 12 can be employed to achieve corresponding valve opening or closing positions in relation to the positions shown in FIG. 13.

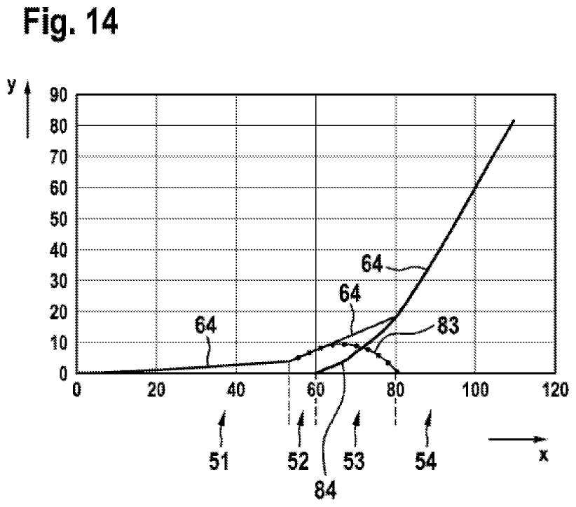

FIG. 14 shows a schematic diagram for a characteristic curve 64 of a hydraulic opening cross-section of the valve 1 depending on an angular position of the valve element 4. The characteristic curve 64 represents the sum of the hydraulic opening cross-section for the first through-opening and the first and second recesses. In addition, starting at the angle of 60°, a second characteristic curve 83 is shown as a dash point line for the behavior of the hydraulic opening cross-section for the first and second recesses. Furthermore, starting at the angle of 60° with a third characteristic curve 84, the behavior of the hydraulic opening cross-section is shown only for the first through-opening 13. Along the y-axis, the hydraulic opening cross-section is shown in square millimeters. Along the x-axis, a rotational position of the valve element 4 in degrees of the angle is shown. In a first angle range 51, which is between 0° and 55° relative to a set rotational position of the valve element, an overlap of the first connection opening 10 with the first recess 15 begins, as shown, for example, in FIG. 6. As the angle of rotation increases, the hydraulic opening cross-section increases nearly linearly, in particular linearly. If the valve element 4 is rotated further, there is a transition to a second angle range 52 at approximately 55°. Between the first and second angle ranges 51, 52, the slope of the characteristic curve 64 changes. This is caused, for example, by the overlap between the first recess 15 and/or a second or third recess 16, 22 increasing with the first connection opening 10. From a 60° angular position, a third angle range 53 begins, in which a direct overlap between the first through-opening 13 and the first connection opening 10 takes place, for example, as shown in FIG. 7. At this point, the third characteristic curve 84 begins. Simultaneously, the influence of the first and second recesses decreases as shown by the dash point line until no medium flows over the first or second recess at the angular position of 80°, but only directly over the first through-opening 13, the through-bore 12 and the second through-opening 14. In the range between 60° and 80°, a superposition of the hydraulic opening cross-sections of the through-bore and the at least one recess takes place. From the fourth angle range 54, the slope of the characteristic curve of the hydraulic opening cross-section 64 changes with the increase in angular position relative to the third angle range 53. Overall, it is possible to achieve improved linearization of the increase of the hydraulic opening cross-section by increasing the rotational position or the angular position of the valve element by using the proposed valve.

All described embodiment examples of the valves serve to linearize the hydraulic opening behavior of the through-bores by using the recesses.

The valve can be used, for example, in a cooling circuit, in particular in a heat pump system of a vehicle. The recesses represent so-called expansion recesses. In the shown embodiment, the first connection opening aligns with the second connection opening and can therefore be connected to one another by a straight-line through-bore formed in the valve element nearly without pressure drops. Depending on the application selected, the first and/or second connection opening can be connected to the conduit at the higher pressure.

The proposed valve allows the at least one recess and the through-bore or openings to have no direct connection in the valve element; wherein, however, a hydraulic connection between the at least one recess and the through-bore can be established by forming the intermediate space. Therefore a desired opening behavior of the valve, in particular a desired increase in the hydraulic opening cross-section, can be determined by a corresponding superposition with the increase in the angular position of the valve element.

Depending on the selected embodiment, for example, at least one or more recesses can be provided solely in the area of the first through-opening in the outer surface of the valve element. Furthermore, the second through-opening can be significantly larger in order to simultaneously connect the second through-opening 14 to the second through-opening 11 in the angular positions in which a connection between the first connection opening and the through-opening 13 via the recess is achieved. Depending on the chosen embodiment, the first and second connection openings can also be formed differently.

1. A valve (1) for a fluid flow in a vehicle with a housing (2), with at least one first and one second connection opening (10, 11) which open into a valve chamber (3) of the housing (2), wherein a valve element (4) is rotatably mounted about an axis of rotation (5) in the valve chamber (3), two spaced-apart through-openings (13, 14) being provided on an outer surface (8) of the valve element (4) and connected to one another by a channel (12), wherein (4) at least one recess (15, 16, 22) is provided, wherein a drive element (6) is provided, with which the valve element (4) is rotatable about the axis of rotation (5),
wherein the at least one recess (15, 16, 22) of the valve element (4) is formed at least partially in the outer surface (8) of the valve body (4), wherein the at least first connection opening (10), the first through-bore (13) and the at least one recess (15, 16, 22) are arranged in an area relative to the pivot axis (5) such that, for a predetermined rotational position range of the valve element (4) with an increase in a rotational angle of the valve element (4), a hydraulic opening cross-section between the first connection opening (10) and the recess (15, 16, 22) decreases, while a hydraulic opening cross-section between the first connection opening (10) and the first through opening (13) increases.

2. The valve according to claim 1, wherein the recess (15, 16, 22), the first through-opening (13) and the first connection opening (10) are formed such that in a first rotational position range of the valve element (4), the recess (15, 16, 22) has a first overlap with the first connection opening (10) and a second overlap with an intermediate space (21), and establishes a connection between the first connection opening (10) and the intermediate space (21), wherein the first through-opening (13) comprises a third overlap with the intermediate space (21),
wherein, after rotating the valve element (4) in a rotational direction (17) in a second rotational position range, the recess (15, 16, 22) has a first overlap with the first connection opening (10) and a second overlap with the intermediate space (21), and wherein the first through-opening (13) comprises a fourth overlap with the first connection opening (10) and a third overlap with the intermediate space (21), and wherein the second through-opening (14) has a connection to the second connection opening (11).

3. The valve according to claim 2, wherein the recess (15, 16, 22), the first through-opening (13) and the first connection opening (10) are formed such that upon further rotation of the valve element (4) in the rotational direction in a third rotational position range, the recess (15, 16, 22) has no overlap with the first connection opening (10), the first through-opening (13) comprises a fourth overlap with the first connection opening (10) and no third overlap with the intermediate space (21), and wherein the second through-opening (14) has a connection to the second connection opening (11).

4. The valve according to claim 2, wherein the first rotational position range extends over a predetermined first angle range, wherein the recess (15, 16, 22), the first through-opening (13) and the first connection opening (10) are formed such that in the first rotational position range, a hydraulic opening cross-section between the first connection opening (10) and the recess (15, 16, 22) and the first through-opening (13) increases with an increasing angle of rotation of the valve element (4).

5. The valve according to claim 2, wherein the second rotational position range extends over a predetermined second angle range, wherein the recess (15, 16, 22), the first through-opening (13) and the first connection opening (10) are formed such that in the second rotational position range with an increasing angle of rotation of the valve element (4), the hydraulic opening cross-section between the first connection opening (10) and the recess (15, 16, 22) and the first through-opening (13) increases.

6. The valve according to claim 1, wherein the recess is formed in a shape of a first partial recess (15) and at least a second partial recess (16), wherein the first and second partial recesses (15, 16) are separated from each other, and wherein the first and second partial recesses (15, 16) are arranged adjacently along the direction of rotation in a partial section.

7. The valve according to claim 1, wherein the recess (15, 16, 22) extends along a predetermined distance to the first through-opening, and wherein an end surface (19) of the recess (16) that faces an edge area (20) of the first through-opening (13) is formed in a spaced area along the edge area (20) of the first through-opening (13).

8. The valve according to claim 1, wherein the recess is introduced into a first and second partial section (23, 24), wherein the first partial section (23) is formed as a straight section along the direction of rotation, wherein the straight section is oriented towards the first through-opening (13), wherein the second partial section (24) is located at an end of the straight first partial section (23), which faces the first through-opening (13), branches laterally from the straight orientation of the first partial section (23), and extends upwards or downwards over a predetermined area along the axis of rotation (5) along an edge section (20) of the first through-opening (13).

9. The valve according to claim 8, wherein the recess comprises a third partial section (25), wherein the third partial section (25) at the end of the straight first partial section (23) that faces the first through-opening (13) branches laterally from the straight orientation of the first partial section (23) opposite the second partial section (24) and extends along the edge section (20) of the first through-opening (13).

10. The valve according to claim 9, wherein the second and third partial sections (24, 25) form a partial circle.

11. The valve according to claim 9, wherein the second and third partial sections (24, 25) form a partial circle, wherein the partial circle has a circular arc shape on a first side that faces the first through-opening (13), and wherein the partial circle has two boundary surfaces arranged in a straight orientation at an angle to each other on a second side opposite to the first side.

12. The valve according to claim 1, wherein a further first recess (28) of the valve element (4) is formed in the outer surface (8) of the valve element (4) in an area of the second through-opening (14), separately from the second through-opening (14), wherein the further first recess (28), the second through-opening (14) and the second connection opening (11) are formed such that in a first rotational position range of the valve element (4), the further first recess (28) has a first overlap with the second connection opening (14) and a second overlap with an intermediate space (21), and establishes a connection between the second connection opening (11) and the intermediate space (21), and wherein the second through-opening (14) has a third overlap with the intermediate space (21), wherein, after rotating the valve element (4) in the rotational direction in a second rotational position range, the further first recess (28) has a first overlap with the second connection opening (11) and a second overlap with the intermediate space (21), and the second through-opening (14) has a fourth overlap with the second connection opening (11) and a third overlap with the intermediate space (21).

13. The valve according to claim 12, wherein the further first recess (28), the second through-opening (14) and the second connection opening (11) are formed such that upon further rotation of the valve element (4) in the rotational direction (17) in a third rotational position range, the further first recess (28) does not have any overlap with the second connection opening (11), and wherein the second through-opening (14) has a fourth overlap with the second connection opening (11) and no more overlap with the intermediate space (21).

14. The valve according to claim 1, wherein the outer surface (8) of the valve element (4) comprises two partial surfaces which are formed in mirror symmetry to the axis of rotation (5) of the valve element (4).

15. The valve according to claim 1, wherein the first and second connection openings (10, 11) each have a seal seat (71, 72), wherein a seal seat (71, 72) seals the connection opening (10, 11) from an intermediate space (21) that is formed between the housing (2) and the valve element (4).

16. The valve according to claim 4, wherein the hydraulic opening cross-section between the first connection opening (10) and the recess (15, 16, 22) and the first through-opening (13) increases linearly with an increasing angle of rotation of the valve element (4).

17. The valve according to claim 5, wherein the hydraulic opening cross-section between the first connection opening (10) and the recess (15, 16, 22) and the first through-opening (13) increases linearly with an increasing angle of rotation of the valve element (4).

18. The valve according to claim 7, wherein the end surface (19) of the recess (16) that faces the edge area (20) of the first through-opening (13) is formed parallel to the edge area (20).

19. The valve according to claim 10, wherein the second and third partial sections (24, form a partial circle in mirror symmetry to a central axis (26) of the first partial section (23).
